(19) United States
(12) Patent Application Publication
(10) Pub. No.: US 2025/0100320 A1
(43) Pub. Date: Mar. 27, 2025

(54) SPIN AND/OR SPIRAL DECORATING DEVICE FOR ARTWORK

(71) Applicant: CRAYOLA LLC, EASTON, PA (US)

(72) Inventors: ROBERT HENRY, BETHLEHEM, PA (US); JOSEPH MOLL, BETHLEHEM, PA (US); YING K. HO, BETHLEHEM, PA (US); GREGORY NUNGESTER, MILFORD, NJ (US)

(21) Appl. No.: 18/890,844

(22) Filed: Sep. 20, 2024

Related U.S. Application Data
(60) Provisional application No. 63/540,420, filed on Sep. 26, 2023.

(51) Int. Cl. B43L 11/06; B43L 13/20

(52) U.S. Cl. CPC B43L 11/06; B43L 13/201

(57) ABSTRACT

A spiral decorating device having a first gear and a second gear for placement in an opening defined by the first gear. The second gear is rotatable around an axis of the second gear as it moves in engagement with the first gear. The second gear has an opening to receive a decorating item. A guide plate has a slot configured to receive the second gear. The guide plate is configured to be positioned in the first gear opening and maintain the second gear in engagement with the first gear as the second gear rotates and the guide plate rotates in the first gear opening. A spin and spiral decorating device with first and second gears, as described above, and a spin plate configured to rotatably engage a base of the device and extend through the first gear opening when the second gear is removed.

### CROSS-REFERENCE TO RELATED APPLICATIONS

This application is based on and claims priority to U.S. Provisional Application Ser. No. 63/540,420, filed on Sep. 26, 2023, which is incorporated herein by reference in its entirety.

### BACKGROUND

Spiral decorating devices may be used to create a variety of spiral type designs on substrates such as paper or cardstock. Typical spiral decorating devices include a set of gears that can move in engagement with each other. The gears include openings for receiving the tip of a pencil, pen, or marker. In a typical mode of use, the gears are placed on top of a piece of paper or cardstock. One gear is held in place, and another gear is placed in engagement with the stationary gear. The tip of a marker is positioned in one of the openings of the gear. The marker is moved to rotate the gear around its central axis. As the gear rotates, it also moves around the stationary gear in engagement with the teeth of the stationary gear. As the gear rotates and moves around the stationary gear, the marker draws a spiral pattern on the paper. While these devices can be used to produce unique spiral patterns, they are often difficult to use, especially for younger children. To produce a consistent pattern, the teeth of the moving gear need to remain in contact with the teeth of the stationary gear. It is often difficult to maintain this contact when moving the gear by rotating it with the tip of a marker, pencil, or pen. The user must also hold the marker, pencil, or pen in order to drive and guide rotation of the gear. The stationary gear also needs to remain stationary when completing the pattern. It is also difficult to hold the stationary gear in place while at the same time rotating the moving gear.

Spin decorating devices are another type of toy that may be used to create unique designs on paper or cardstock. Typical spin decorating devices include a table for rotation by a user. A sheet of paper or cardstock is secured to the table. While the table spins, paint or ink can be dripped on the sheet to create a unique pattern. Paint brushes, fingers, or other items can be used, as desired, while the table spins to move the paint or ink across the sheet.

One existing device includes both spin and spiral decorating functions. The device includes a housing with a spiral decorating device integrated into one end of the housing and a spin decorating device integrated into the opposite end of the housing. The spin and spiral decorating functions of the device operate independently of each other. The spiral decorating device includes a fixed outer gear that is part of the housing and removable inner gears that engage the outer gear. As with the spiral decorating devices described above, in order to obtain a consistent spiral pattern, the inner gear needs to remain in contact with the outer gear as the inner gear rotates. It is often difficult to maintain such contact when rotating the inner gear with the tip of a marker, pen, or pencil. The user must also hold the marker, pencil, or pen in order to drive and guide rotation of the gear. While the combined device can be used for both spin and spiral decorating, it is fairly large since it includes separate areas for spin decorating and spiral decorating.

### SUMMARY

A spiral decorating device in accordance with one exemplary aspect of the invention described herein includes a first gear defining a first opening around which the first gear extends. A second gear is configured to be positioned in the first opening and engage the first gear. The second gear is configured to rotate around an axis of the second gear as the second gear moves in engagement with the first gear. The second gear defines a second opening configured for receiving a decorating item. A guide plate defines a slot configured to receive the second gear. The guide plate is configured to be positioned in the first opening of the first gear when the slot receives the second gear, and the guide plate is configured to maintain the second gear in engagement with the first gear as the second gear rotates and the guide plate rotates within the first opening.

In some embodiments, the guide plate includes at least one post configured to allow a user to rotate the guide plate within the first opening while the second gear moves in engagement with the first gear and the second gear rotates.

In some embodiments, a third gear is configured to be positioned in the first opening and engage the first gear. The third gear is configured to rotate around an axis of the third gear as the third gear moves in engagement with the first gear. The third gear defines a third opening configured for receiving another decorating item. The guide plate defines a second slot configured to receive the third gear. The guide plate is configured to be positioned in the first opening of the first gear when the second slot receives the third gear, and the guide plate is configured to maintain the third gear in engagement with the first gear as the third gear rotates and the guide plate rotates within the first opening.

In some embodiments, the guide plate has a wall that defines the slot. Upper and lower engagement surfaces extend from the wall of the guide plate. The upper and lower engagement surfaces engage the second gear when the second gear is positioned in the slot.

A spin and spiral decorating device in accordance with another exemplary embodiment of the invention described herein includes a base with a first gear. The first gear defines a first opening around which the first gear extends. A second gear is configured to be positioned in the first opening and engage the first gear. The second gear is configured to rotate around an axis of the second gear as the second gear moves in engagement with the first gear, and the second gear defines a second opening configured for receiving a decorating item. A spin plate is configured to rotatably engage the base with at least a portion of the spin plate extending through the first opening when the second gear is removed from the first opening.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of a spin and spiral decorating device in accordance with an exemplary embodiment of the invention described herein with the device shown for operation in a spiral mode;

FIG. 2 is a top plan view of the device shown in FIG. 1 with a guide plate and gears removed;

FIG. 3 is a top plan view similar to FIG. 1 with an item to be decorated placed on a base of the device;

FIG. 4 is a perspective view of a guide plate of the device shown in FIG. 1;

FIG. 5 is a close up view of a slot of the guide plate shown in FIG. 4;

FIG. 6 is a perspective view of a gear of the device shown in FIG. 1;

FIG. 7 is a top plan view of the gear shown in FIG. 6;

FIG. 8 is a perspective view of another gear of the device shown in FIG. 1;

FIG. 9 is a top plan view of the gear shown in FIG. 8;

FIG. 10 is a perspective view of the spin and spiral decorating device shown in FIG. 1 with the device shown for operation in a spin mode;

FIG. 11 is a perspective view similar to FIG. 10 with an item to be decorated removed from a spin plate of the device;

FIG. 12 is a top perspective view of the spin plate of the device shown in FIG. 10;

FIG. 13 is a bottom perspective view of the spin plate shown in FIG. 12;

FIG. 14 is a bottom perspective view of the device shown in FIG. 1;

FIG. 15 is a bottom plan view showing gears of a spin mechanism of the device shown in FIG. 1;

FIG. 16 is a top plan view of the gears shown in FIG. 15;

FIG. 17 is an exploded view of an actuator of the spin mechanism;

FIG. 18 is a cross-sectional view taken through the line 18-18 shown in FIG. 2;

FIG. 19 is a perspective view of an alternative embodiment of spin and spiral decorating device;

FIG. 20 is a perspective view of a swing arm of the device shown in FIG. 19;

FIG. 21 is a perspective view of a rake arm of the device shown in FIG. 19 showing one side of the arm;

FIG. 22 is a perspective view of the rake arm shown in FIG. 21 showing an opposite side of the arm;

FIG. 23 shows an exemplary pattern that may be produced by the devices shown in FIGS. 1 and 19 when operating in a spiral mode;

FIG. 24 shows an exemplary pattern that may be produced by the device shown in FIG. 19 when operating in a spin mode with the swing arm shown in FIG. 20;

FIG. 25 shows another exemplary pattern that may be produced by the device shown in FIG. 19 when operating in a spin mode with the swing arm shown in FIG. 20;

FIG. 26 shows an exemplary pattern that may be produced by the device shown in FIG. 19 when operating in a spin mode with the rake arm shown in FIG. 21; and

FIG. 27 shows another exemplary pattern that may be produced by the device shown in FIG. 19 when operating in a spin mode with the rake arm shown in FIG. 21.

### DETAILED DESCRIPTION OF EXEMPLARY EMBODIMENTS

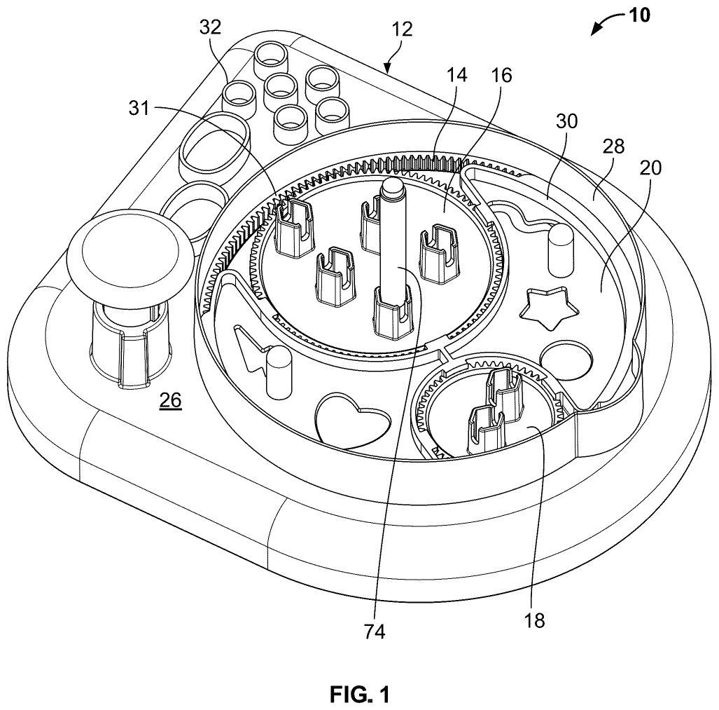

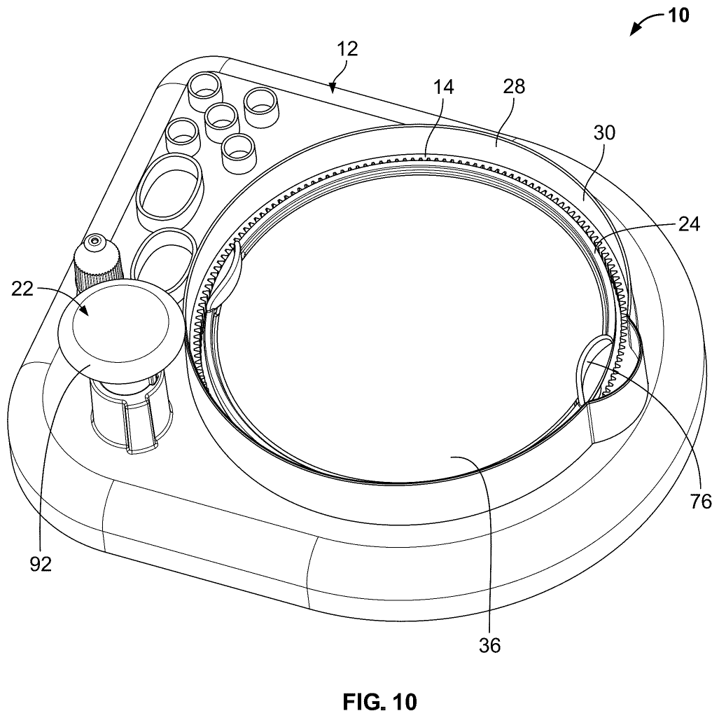

A spin and spiral decorating device in accordance with one embodiment of the invention described and claimed herein is identified generally as 10 in FIG. 1. As described in more detail below, the spin and spiral decorating device 10 is configured for use to decorate items such as paper or cardstock. The device 10 is configured for use to decorate items in a spiral mode when configured as shown in FIG. 1 and a spin mode when configured as shown in FIG. 10. It is also within the scope of the invention for the device to be configured for use in only one of the spiral mode or the spin mode.

Referring to FIG. 1, the spin and spiral decorating device 10 broadly includes a base 12, a first gear 14, second and third gears 16 and 18 that are configured to engage the first gear 14, and a guide plate 20 configured to maintain the second and third gears 16 and 18 in engagement with the first gear 14. Referring to FIG. 10, the spin and spiral decorating device 10 further includes a spin mechanism 22 and a spin plate 24, which may be coupled to the spin mechanism when the second and third gears 16 and 18 and guide plate 20 are removed from the base 12.

The base 12 includes an upper surface 26 and a wall 28 extending upward from the upper surface 26 to define a receptacle 30 within which the second and third gears 16 and 18 and guide plate 20 are positioned. The first gear 14 is positioned at the bottom of the wall 28 within the receptacle 30. The first gear 14 may be formed integrally with the base 12. For example, the base 12 and first gear 14 may be formed from a polymeric material, e.g., molded plastic. The wall 28 and first gear 14 are generally circular as shown in FIG. 1, although they may be formed in other suitable shapes. The first gear 14 defines a first opening 31 around which the first gear 14 extends. The first gear 14 is structured as a ring gear with internal teeth facing the receptacle 30. The base 12 further includes a plurality of tubes, one of which is identified as 32, that extend upward from the upper surface 26. The tubes 32 are configured to hold a plurality of decorating items, such as markers, pens, paint brushes, pencils, paint containers, or any other suitable type of decorating item that may be used and/or provided with the device 10.

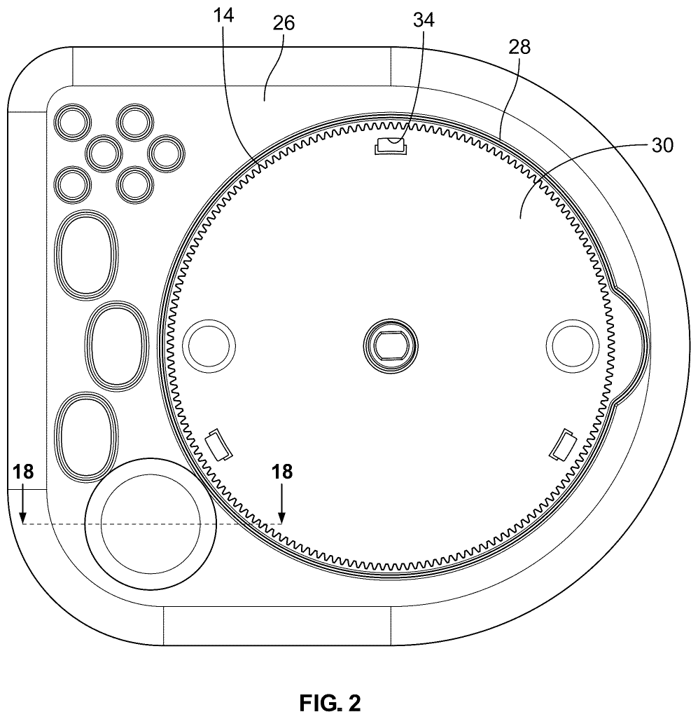

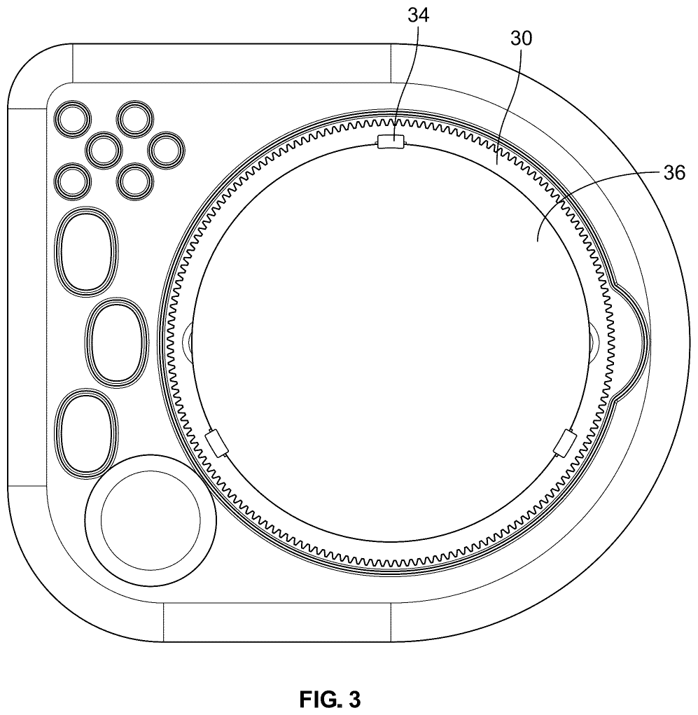

As shown in FIG. 2, three clips, one of which is identified as 34, extend upward from the upper surface 26 within the receptacle 30. The clips 34 are configured to retain an item to be decorated, such as a piece of paper or cardstock, within the receptacle 30. FIG. 3 shows an item 36 retained by the clips 34 within the receptacle 30.

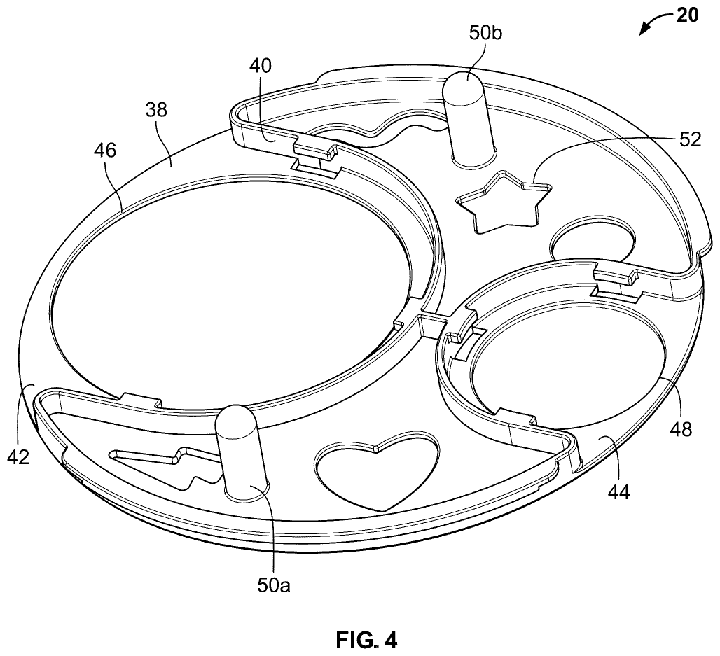

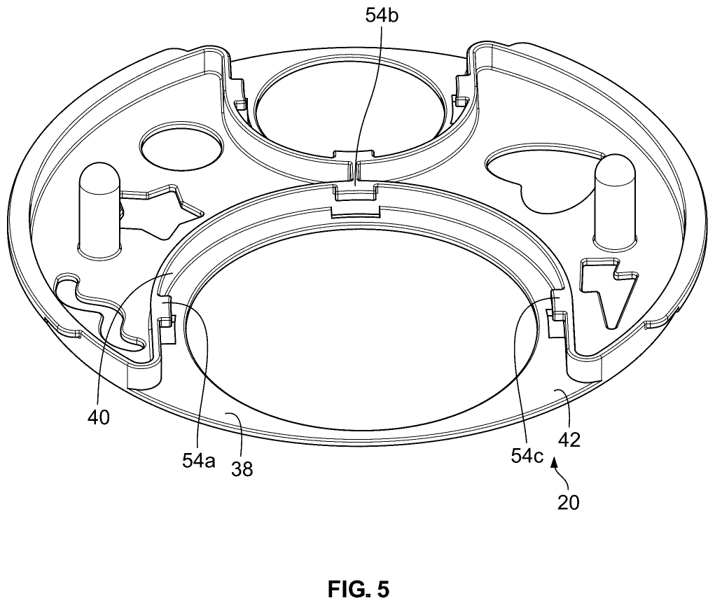

The guide plate 20 is described in more detail with reference to FIGS. 4 and 5. The guide plate 20 includes a base 38 that is generally circular and sized to fit within the first opening 31 (FIG. 1) of the first gear 14. A wall 40 extending upward from the base 38 defines first and second slots 42 and 44 that are configured to receive the second and third gears 16 and 18, respectively. As shown in FIG. 4, the wall 40 extends continuously across the guide plate 20 in a serpentine manner to form both of the first and second slots 42 and 44. The wall 40 may alternatively be formed from discrete sections that are not connected to each other to form the slots 42 and 44. Further, the guide plate 20 may be formed to only have one of the first and second slots 42 and 44, or any other suitable number of slots for receiving gears similar to the second and third gears 16 and 18. Within the slots 42 and 44, openings 46 and 48 are formed in the base 38 of the guide plate 20. The openings 46 and 48 allow a decorating item to extend through the guide plate 20 and decorate the item 36 (FIG. 3) in use. The slots 42 and 44 are open at the peripheral edge of the base 38 so that the second and third gears 16 and 18 may engage the first gear 14, as shown in FIG. 1, when the guide plate 20 is inserted in the first opening 31 of the first gear 14. Posts 50a-b extend upward from the base 38. The posts 50a-b may be grasped or manipulated by a user to rotate the guide plate 20 and second and third gears 16 and 18 within the first opening 31 of the first gear 14. Decorative openings in the base 38, one of which is identified as 52, may be used to trace a decorative pattern on the item 36 (FIG. 3). If the first gear 14 is a shape other than circular, the base 38 of the guide plate 20 may be formed from a different shape than the first gear 14 that allows the guide plate 20 to rotate within the first opening 31 of the first gear 14 and maintain contact between the second and third gears 16 and 18 and the first gear 14.

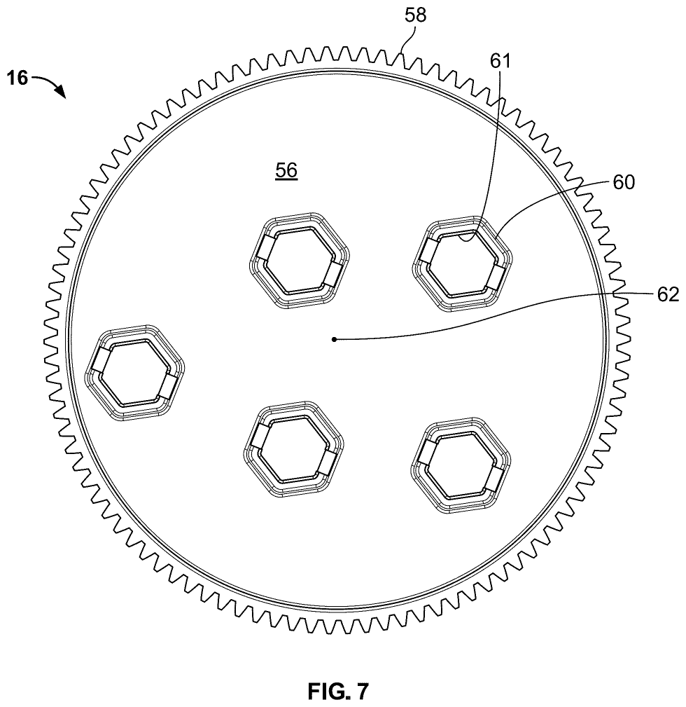

Referring to FIG. 5, the first slot 42 is formed by the base 38 and wall 40. Tabs 54a-c extend outward from the wall 40 over the first slot 42. Lower surfaces of the tabs 54a-c form upper engagement surfaces that engage an upper surface of the second gear 16 when it is positioned in the first slot 42. The base 38 forms a lower engagement surface that engages a lower surface of the second gear 16. The spacing between the base 38 and tabs 54a-c allows the second gear 16 to be inserted into the first slot 42 through the opening at the peripheral edge of the base 38. The tabs 54a-c and base 38 restrain the second gear 16 from moving vertically with respect to the guide plate 20, and the wall 40 restrains the second gear 16 from moving laterally with respect to the guide plate 20. The wall 40 around the first slot 42 is sized so that the second gear 16 can rotate within the slot around a central axis 62 (FIG. 7) of the second gear 16. The second slot 44 (FIG. 4) has a similar structure as the first slot 42 and is configured to retain the third gear 18, as shown in FIG. 1. The guide plate 20 may include other specific configurations designed to maintain engagement between the second and third gears 16 and 18 and the first gear 14 while the guide plate 20 rotates.

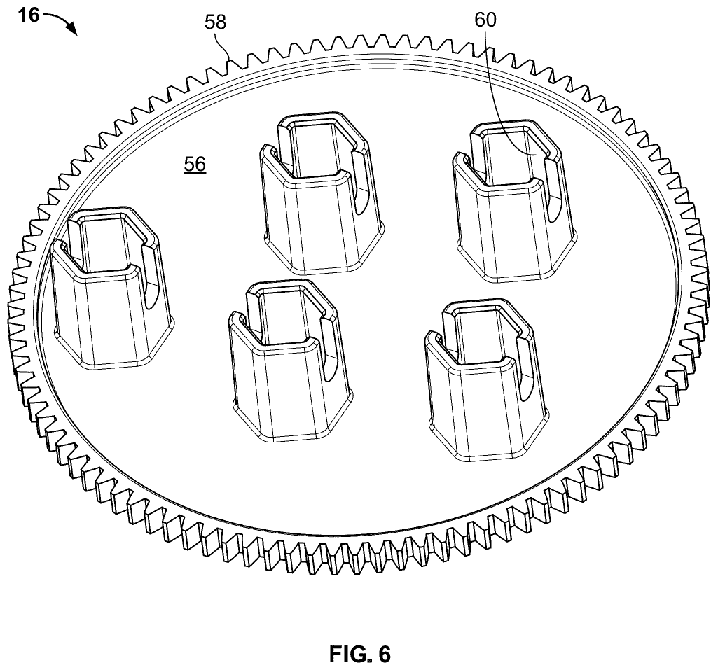

As shown in FIGS. 6 and 7, the second gear 16 is generally circular with a base 56 and gear teeth 58 extending outward from the outer peripheral edge of the base 56. Receptacles, one of which is identified as 60, extend upward from the base 56 around openings, one of which is identified as 61 in FIG. 7, in the base. The receptacles 60 are configured to receive decorating items such as markers, paint pens, paint brushes, pencils, etc. The receptacles 60 are polygonal, which may make it easier to insert and remove decorating items from the receptacles. The second gear 16 has a central axis 62 (FIG. 7) around which the second gear 16 rotates. The receptacles 60 are radially spaced from the central axis 62 different distances to provide different options for the pattern created by a decorating item inserted into one of the receptacles. For example, a receptacle closer to the central axis 62 will draw a spiral pattern with a narrower width than a receptacle farther away from the central axis 62. Further, multiple receptacles 60 may be used at the same time to simultaneously draw different patterns on the item 36. Although the second gear 16 is shown as being circular, it may be formed in a shape other than circular.

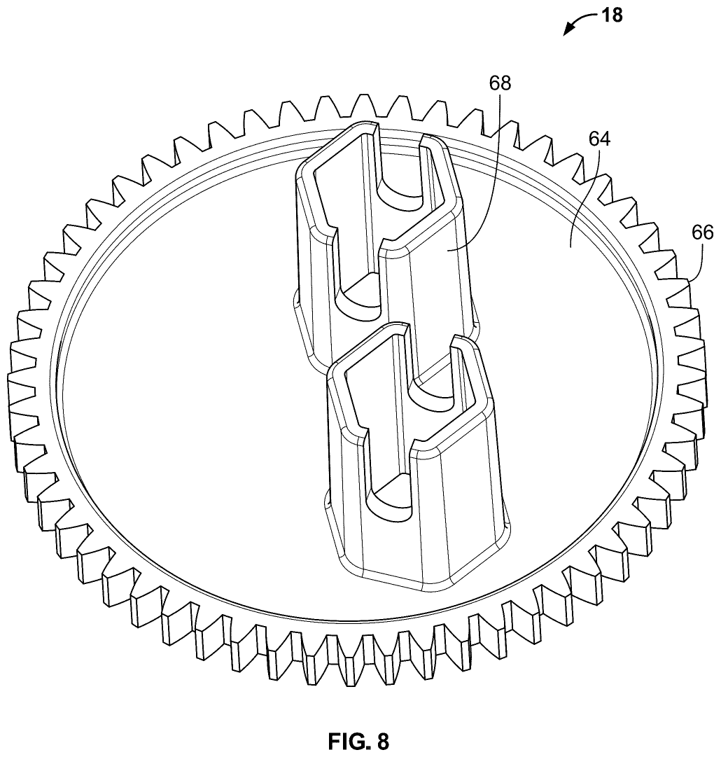

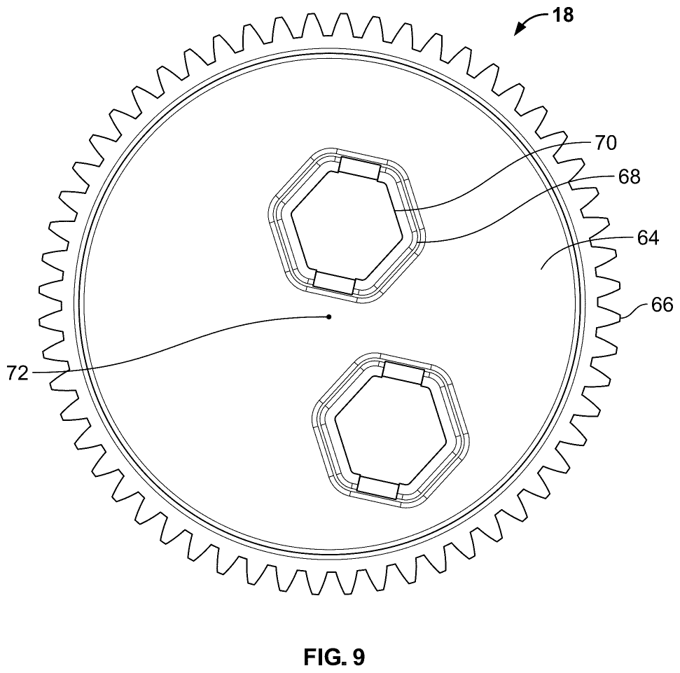

The third gear 18 is shown in more detail in FIGS. 8 and 9. Like the second gear 16, the third gear 18 has a base 64 and gear teeth 66 extending outward from the outer peripheral edge of the base 64. Receptacles, one of which is identified as 68, extend upward from the base 64 around openings, one of which is identified as 70 in FIG. 9, in the base. The receptacles 68 are configured to receive decorating items and are polygonal as described above. The third gear 18 has a central axis 72 (FIG. 9) around which the third gear 18 rotates. The receptacles 68 are radially spaced from the central axis 72 different distances to provide different options for the pattern created by a decorating item inserted into one of the receptacles. Although the third gear 18 is shown as being circular, it may be formed in a shape other than circular. The third gear 18 has a smaller diameter than the second gear 16 to provide different options for the patterns created by decorating items used with the third gear 18 versus the second gear 16.

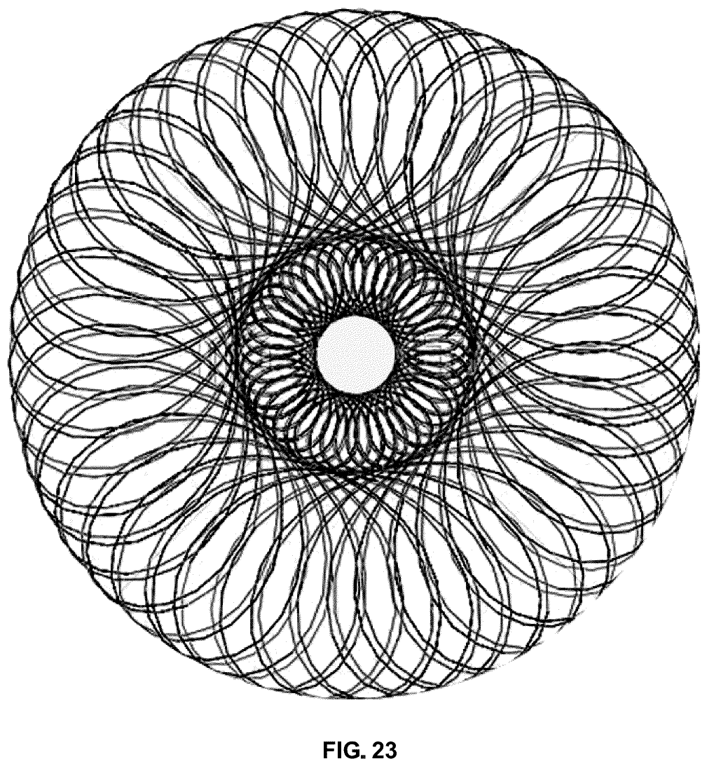

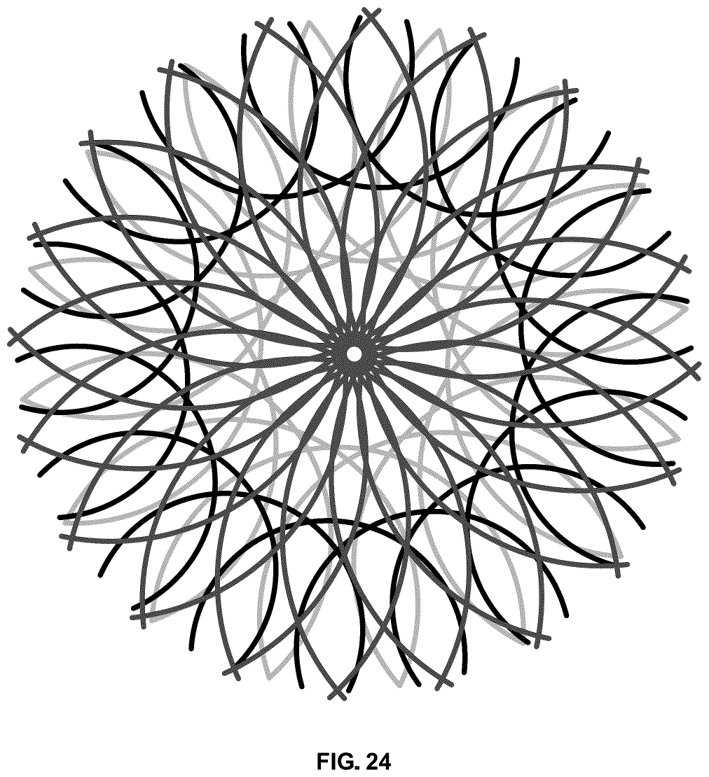

Referring back to the configuration for the spiral mode of use shown in FIG. 1, when the second and third gears 16 and 18 are inserted into the first and second slots 42 and 44 (FIG. 4) of the guide plate 20, the second and third gears 16 and 18 and guide plate 20 can be positioned in the first opening 31 of the first gear 14. The second and third gears 16 and 18 and guide plate 20 are sized so that the gear teeth of the second and third gears 16 and 18 engage the gear teeth of the first gear 14 when the guide plate 20 and second and third gears 16 and 18 are positioned in the first opening 31. The guide plate 20 is configured to maintain the second and third gears 16 and 18 in engagement with the first gear 14 as the guide plate 20 rotates within the first opening 31. For example, when a decorating item such as a marker 74 is inserted into one of the receptacles 60 and the guide plate 20 is rotated about its central axis within the first opening 31 of the first gear 14, rotation of the guide plate 20 causes the second and third gears 16 and 18 to rotate about the central axis of the guide plate 20. As the second and third gears 16 and 18 rotate about the central axis of the guide plate 20, the second and third gears 16 and 18 also rotate about their respective central axes 62 (FIG. 7) and 72 (FIG. 9) due to the engagement between the second and third gears 16 and 18 and the stationary first gear 14. The second and third gears 16 and 18 rotate in the opposite direction as the guide plate 20. The guide plate 20 constrains lateral movement of the second and third gears 16 and 18 as they rotate to maintain the second and third gears 16 and 18 in engagement with the first gear 14. Multiple decorating items, such as marker 74, may be positioned in the receptacles of the second and third gears 16 and 18 to simultaneously draw patterns on the item 36 as the guide plate 20 and second and third gears 16 and 18 rotate within the first opening 31 of the first gear 14. For example, one type of spiral pattern that may be produced is shown in FIG. 23. Unlike with typical spin decorating devices, the user does not need to hold the decorating items in order to move the second and third gears 16 and 18. Instead, the user may rotate the gears 16 and 18 by rotating the guide plate with the posts 50a-b (FIG. 4).

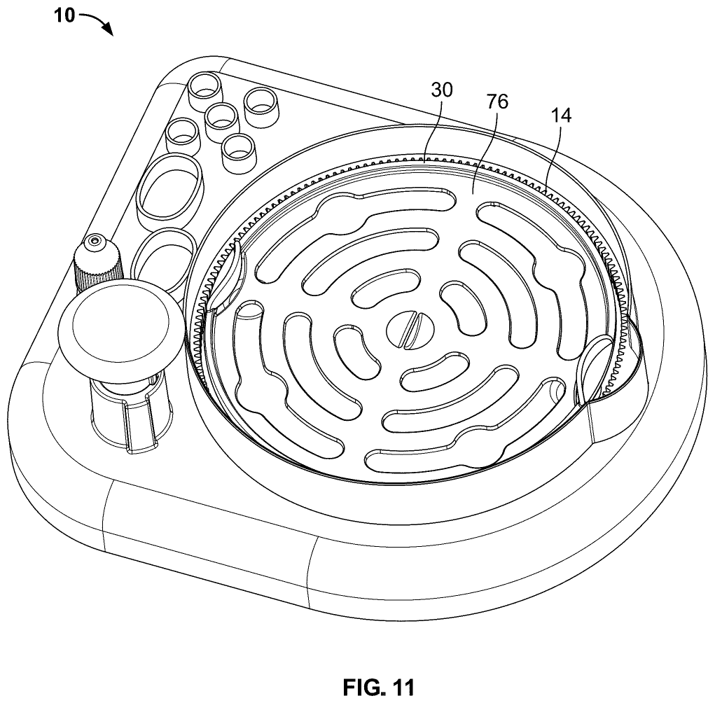

FIG. 10 shows the spin and spiral decorating device 10 configured for use in the spin mode. In the spin mode, the guide plate 20 and second and third gears 16 and 18 are removed from the first opening 31 of the first gear 14. A spin plate 76 is inserted into the receptacle 30 formed by the wall 28. The spin plate 76 is configured to retain the item 36 for decoration. FIG. 11 shows the spin plate 76 without the item 36. The spin plate 76 is configured to be positioned radially inward from and/or above the first gear 14 so that the spin plate 76 can rotate within the receptacle 30 without engaging the first gear 14.

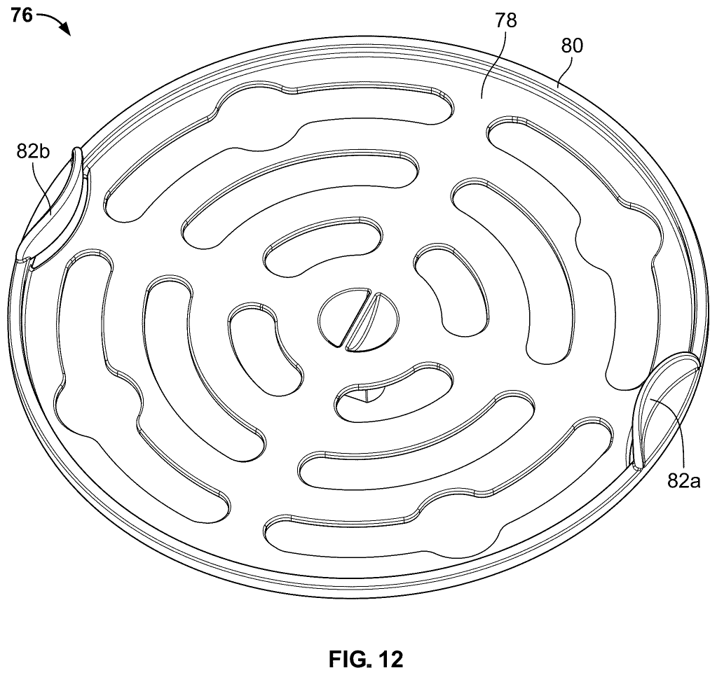

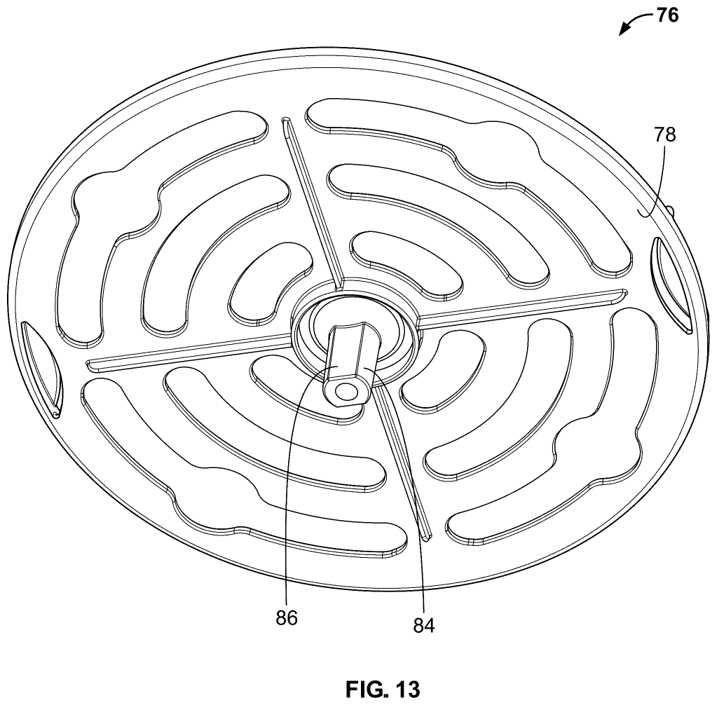

The spin plate 76 is described in more detail with reference to FIGS. 12 and 13. The spin plate 76 is generally circular and includes a base 78 with an upwardly extending lip 80 around the outer peripheral edge of the base 78. A pair of curved tabs 82a-b extend from the upper portion of the lip 80 over the base 78 such that there is a gap between a lower surface of the tabs 82a-b and an upper surface of the base 78. An edge portion of the item 36 (FIG. 10) may be positioned in the gaps between the tabs 82a-b and base 78 to retain the item 36 on the spin plate 76 as it rotates. As shown in FIG. 13, a post 84 extends downward from a lower surface of the base 78. The post 84 has opposing flat sides, one of which is identified as 86, that are configured for reception by a portion of the spin mechanism 22 (FIG. 10), as described in more detail below. The post 84 extends downward through the first opening 31 (FIG. 1) of the first gear 14 when the spin plate 76 is in use.

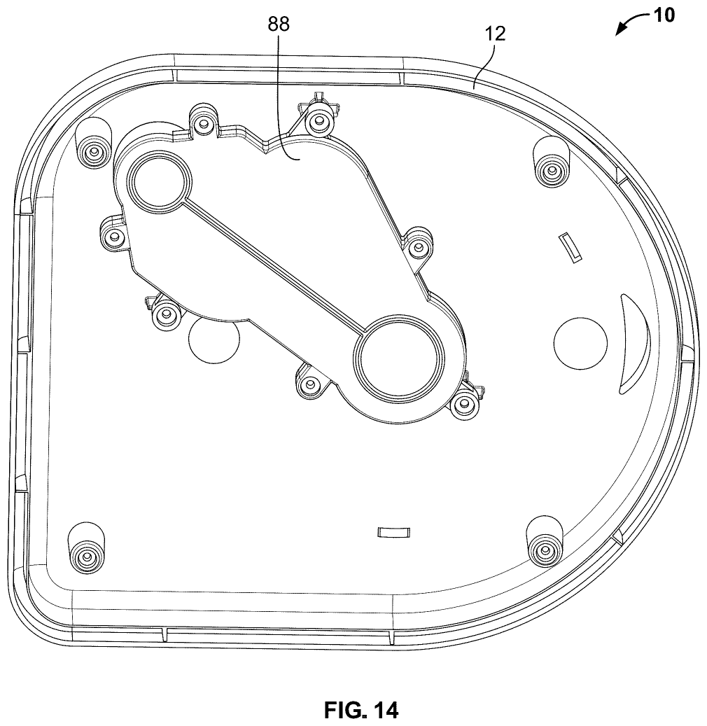

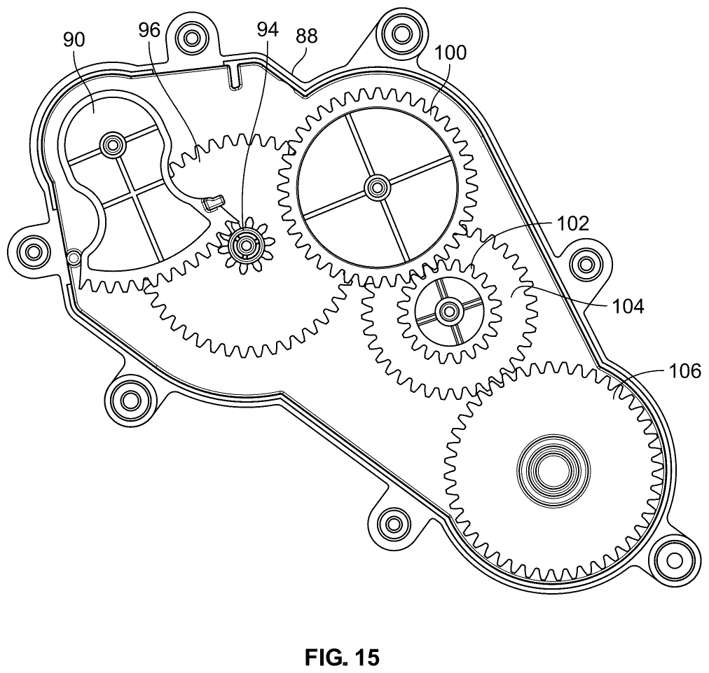

FIG. 14 shows a gear housing 88 of the spin mechanism 22 mounted to a lower surface of the base 12. FIGS. 15 and 16 show an arrangement of gears within the gear housing 88. FIG. 15 is a view showing the bottom of the gears within the housing 88 with a lower portion of the housing removed, and FIG. 16 is a view showing the top of the gears with the entire housing 88 removed. A first gear 90 of the spin mechanism 22 is coupled to an actuator 92 (FIG. 10) as described in more detail below. The first gear 90 engages a second gear 94 shown in FIG. 15. The second gear 94 is fixedly mounted to a third gear 96 such that the second and third gears 94 and 96 rotate together. As shown in FIG. 16, the third gear 96 engages a fourth gear 98. The fourth gear 98 is fixedly mounted to a fifth gear 100 such that the fourth and fifth gears 98 and 100 rotate together. As shown in FIG. 15, the fifth gear 100 engages a sixth gear 102. The sixth gear 102 is fixedly mounted to a seventh gear 104 such that the sixth and seventh gears 102 and 104 rotate together. As shown in FIG. 16, the seventh gear 104 engages an eighth gear 106. The eighth gear 106 includes an upwardly extending post 108 with a receptacle 110 formed in the post 108. The receptacle 110 is keyed to receive the post 84 (FIG. 13) of the spin plate 76 such that the spin plate 76 rotates with rotation of the eighth gear 106. The receptacle 110 is aligned with an opening (not shown) in the base 12 so that the post 84 of the spin plate 76 extends through the base 12 into the receptacle 110.

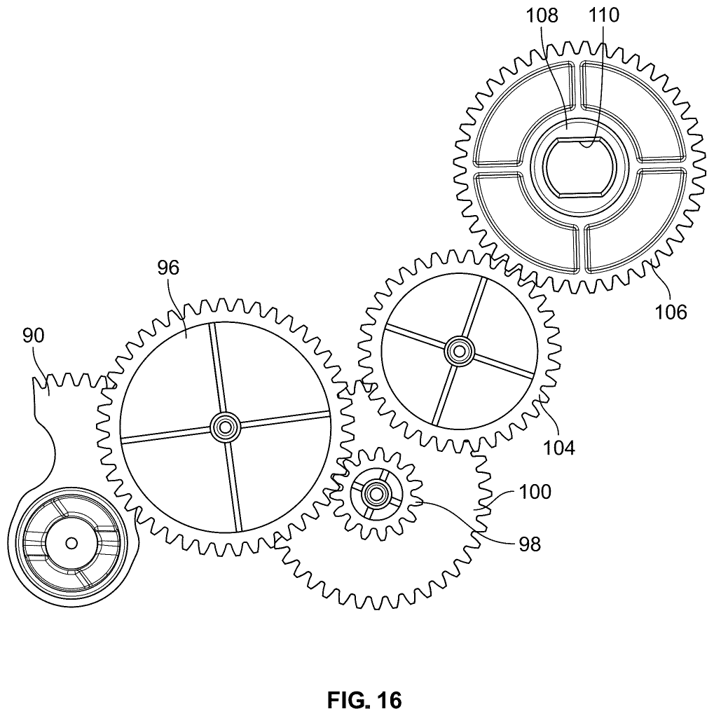

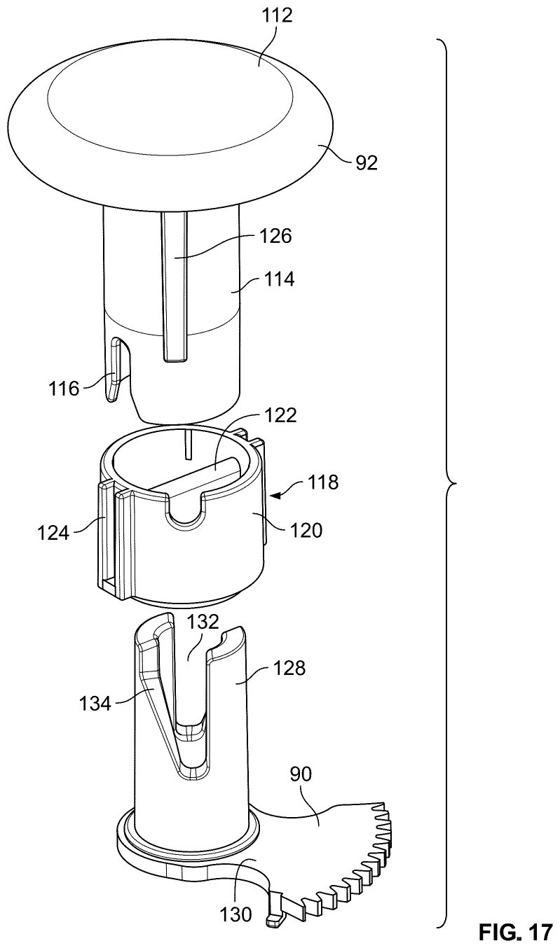

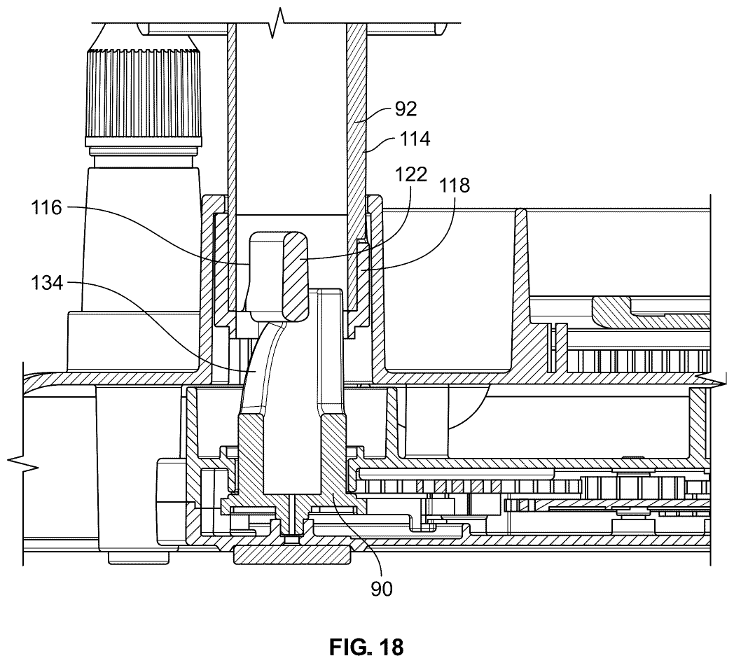

Referring to FIGS. 17 and 18, the actuator 92 is coupled to the first gear 90 in a manner that rotates the first gear 90 when the actuator 92 is pressed downward in a linear manner. The actuator 92 includes a head 112 and a post 114 extending downward from the head. Opposing slots, one of which is identified as 116, are formed in a lower edge of the post 114 and extend vertically upward. A coupler 118 is positioned between the actuator 92 and first gear 90. The coupler 118 has an outer wall 120 that is cylindrical and an inner wall 122 extending between inner sides of the outer wall 120. Anti-rotation structures 124 extending outward from the outer wall 120 engage a portion of the base 12 to limit or prevent rotation of the coupler, and a key 126 on the actuator 92 engages a slot on the base 12 to limit or prevent rotation of the actuator 92. The first gear 90 includes a post 128 extending upward from a base plate 130 of the gear. Opposing slots, one of which is identified as 132, are formed in the post 128 and extend downward from an upper edge of the post 128. Each slot 132 is defined by an angled wall 134 that tapers downward so that the slot 132 is wider at the top of the post 128 than near the bottom of the post 128. The inner wall 122 of the coupler 118 is received within the slot 116 of the actuator 92 such that when the actuator 92 is pressed downward, the coupler 118 also moves downward. A lower edge of the inner wall 122 engages the angled wall 134 defining the slot 132 of the first gear 90. As the actuator 92 and coupler 118 move downward, the inner wall 122 exerts a force on the angled wall 134 that causes the first gear 90 to rotate. Rotation of the first gear 90 causes rotation of the eighth gear 106 and the spin plate 76 coupled to the eighth gear 106.

When using the spin and spiral decorating device 10 in the spin mode, a user may create unique designs by, for example, spinning the spin plate 76, and dripping paint or ink on the item 36 on the spin plate 76. Other types of unique designs may be created by using paint brushes, markers, pencils, or any other desired decorating item while the spin plate 76 spins.

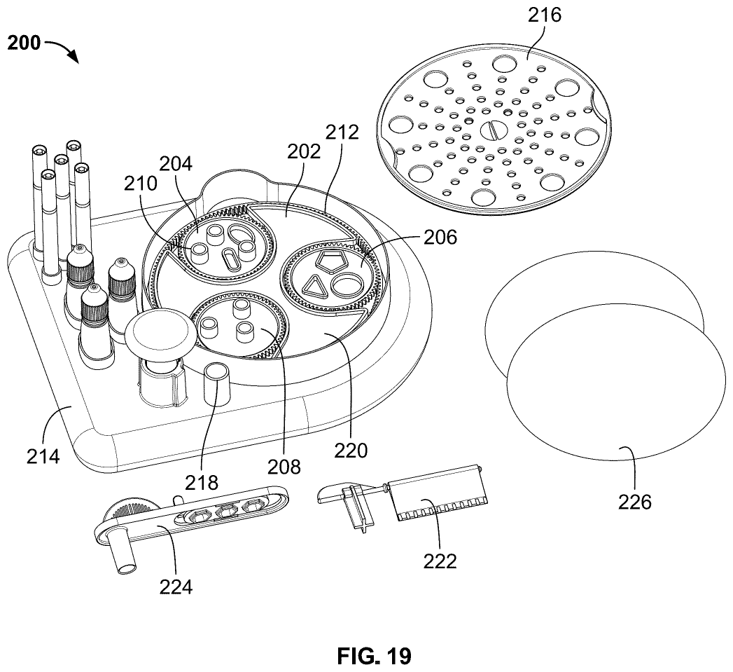

An alternative embodiment of spin and spiral decorating device 200 is shown in FIGS. 19-22. The spin and spiral decorating device 200 is substantially similar to the spin and spiral decorating device 10 except for the differences described herein. The spin and spiral decorating device 200 has a guide plate 202 with three slots each receiving a gear 204, 206, and 208. In the spiral mode, the spin and spiral decorating device 200 may otherwise operate in the same manner described above for the spin and spiral decorating device 10. Since the guide plate 202 does not include posts allowing a user to rotate the guide plate 202, the guide plate 202 and gears 204, 206, and 208 may be rotated by inserting a marker or other decorating device in one of the receptacles (e.g., receptacle 210) on one of the gears 204, 206, 208. The marker may be held by the user and pushed in a direction that rotates the gear 204. Rotation of the gear 204 causes the guide plate 202 to rotate about its central axis, which also causes rotation of the gears 206 and 208 about their central axes due to their engagement with the guide plate 202 and fixed gear 212 of the base 214.

When used in the spin mode, the guide plate 202 and gears 204, 206, 208 are removed and replaced with the spin plate 216. The base 214 has a tube 218 adjacent the receptacle 220 within which the spin plate 216 is placed. The spin and spiral decorating device 200 includes a rake arm 222 and a swing arm 224 that may be used to create unique patterns on the item 226 placed on the spin plate 216.

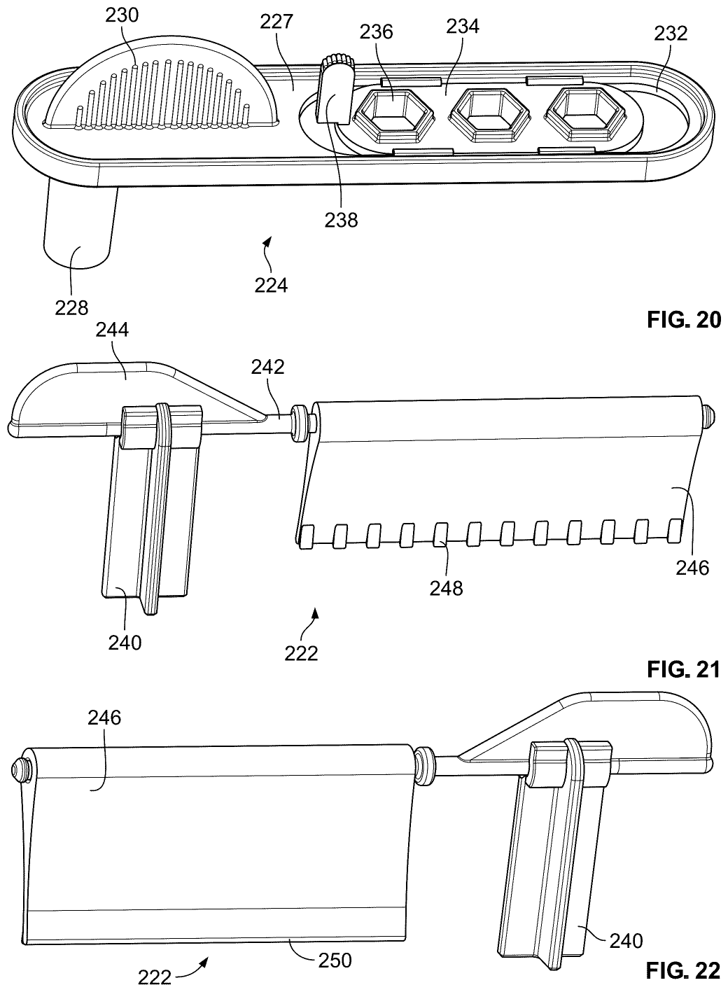

The swing arm 224 is shown in more detail in FIG. 20. The swing arm 224 includes an elongate base 227 with a post 228 extending downward from a lower surface at one end of the base 227. The post 228 is configured to be received in the tube 218 of the base 214. When the post 228 is received in the tube 218, the base 227 extends over the spin plate 216 (FIG. 19) positioned in the receptacle 220. Extending upward from the upper surface of the base 227 is a fin 230, which is configured to allow a user to manipulate the swing arm 224. For example, a user may grasp the fin 230 and rotate the swing arm 224 by rotating the post 228 within the tube 218. The base 227 further includes a slot 232 extending from adjacent the fin 230 at about a midpoint of the base 227 to an end of the base opposite the post 228. A holder 234 is slidably received in the slot 232. For example, sides of the base 227 defining the slot 232 may include tracks that engage the holder 234 and allow it to move fore and aft within the slot 232 from adjacent the midpoint of the base 227 to the end of the base 227. The holder 234 includes three openings, one of which is identified as 236, configured to receive an item for decorating (e.g., a marker). The openings 236 are polygonal to facilitate insertion and removal of the device. The holder 234 further includes an upwardly extending tab 238 that a user may grasp or push to move the holder 234 within the slot 232.

The swing arm 224 may be used with decorating items, such as markers, to create unique patterns. For example, FIG. 24 shows one exemplary pattern that may be created using the swing arm 224. The pattern shown in FIG. 24 may be created by placing a marker in each opening 236 of the holder 234, spinning the spin plate 216, and rotating the swing arm 224 back and forth by rotating the post 228 within the tube 218.

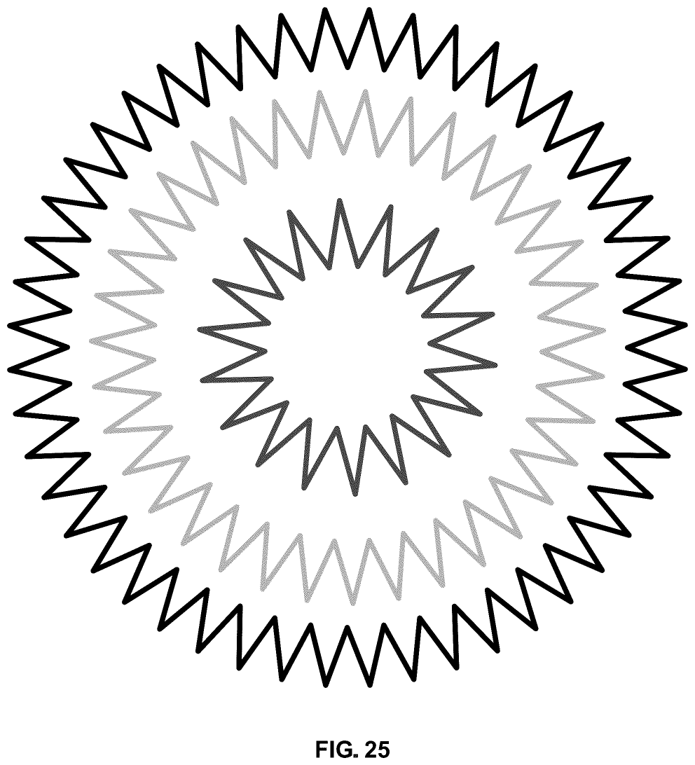

FIG. 25 shows another exemplary pattern that may be created using the swing arm 224. The pattern shown in FIG. 25 may be created again by placing a marker in each opening 236 of the holder 234 and spinning the spin plate 216. Instead of rotating the swing arm 224, the holder 234 is moved back and forth in the slot 232 to create a zig-zag design. Other unique patterns may be created by, for example, rotating the swing arm 224 while also moving the holder 234 back and forth within the slot 232 as the spin plate 216 spins.

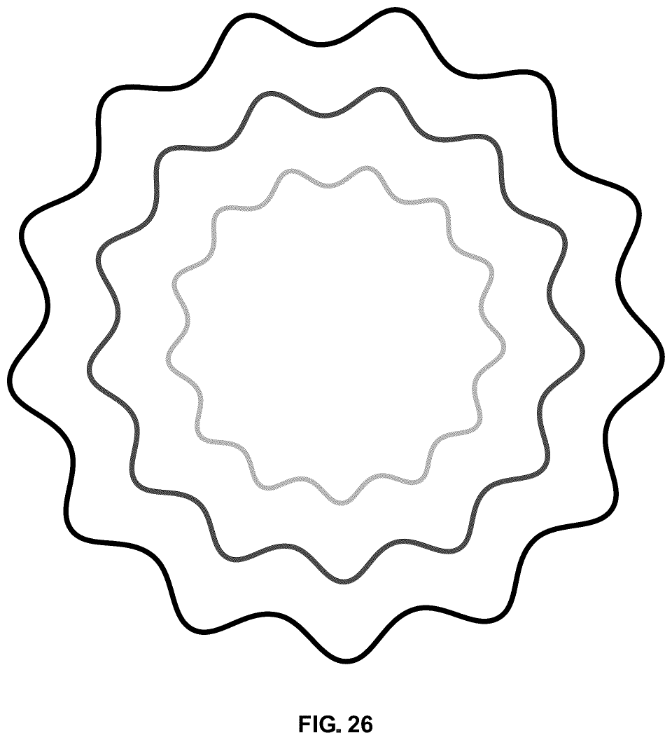

Referring to FIGS. 21 and 22, the rake arm 222 includes a post 240 configured for reception within the tube 218 (FIG. 19) of the base 214. A rod 242 slidably mounts to the post 240 and extends outward from the post 240. When the post 240 is received in the tube 218, the rod 242 extends over the spin plate 216 (FIG. 19) positioned in the receptacle 220. One end of the rod 242 includes a tab 244 that a user may manipulate to move the rod 242 back and forth relative to the post 240. A plate 246 is mounted on the opposite end of the rod 242. The plate 246 may be loosely mounted on the rod 242 such that the plate 246 is capable of rotating at least to a limited extent with respect to the rod 242. A top of the plate 246 is mounted to the rod 242 and a bottom of the plate 246 is configured to engage a decorating item (e.g., paint or ink) deposited on the item 226 on the spin plate 216 (FIG. 19). FIG. 21 shows one side of the plate 246 that includes spaced apart ribs, one of which is identified as 248, positioned at the bottom of the plate. When the plate 246 is oriented so that the spin plate 216 spins toward the ribs 248, a pattern such as the one shown in FIG. 26 may be created by dripping paint or ink on the item 226 and moving the plate 246 back and forth relative to the rod 242.

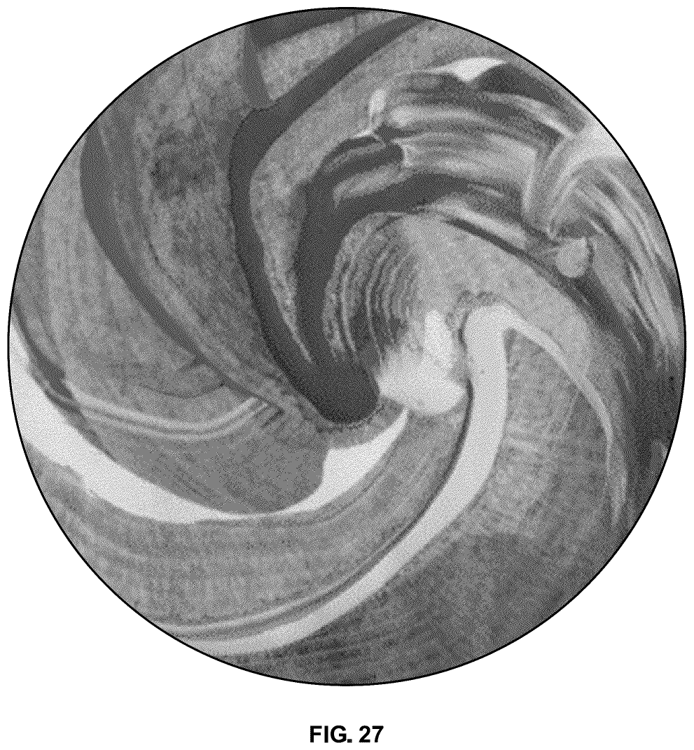

FIG. 22 shows an opposite side of the plate 246, which has a flat edge 250 at the bottom of the plate 246. When the plate 246 is oriented so that the spin plate 216 spins toward the flat edge 250, a pattern such as the one shown in FIG. 27 may be created by dripping paint or ink on the item 226. The flat edge 250 creates a swirl pattern as shown in FIG. 27.

Although the spin and spiral decorating devices 10 and 200 described above are configured for use in both the spin mode and the spiral mode, it is within the scope of this disclosure for the devices 10 and 200 to be configured for use in only one of the spin mode or the spiral mode. For example, the device 10 may be configured as just a spiral decorating device that does not include the spin plate 76 and the spin mechanism 22. Further, the device 10 may be configured as just a spin decorating device that does not include the guide plate 20 and gears 16 and 18.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A spiral decorating device comprising:
a first gear defining a first opening around which the first gear extends;
a second gear configured to be positioned in the first opening and engage the first gear, wherein the second gear is configured to rotate around an axis of the second gear as the second gear moves in engagement with the first gear, and wherein the second gear defines a second opening configured for receiving a decorating item; and
a guide plate defining a slot configured to receive the second gear, the guide plate configured to be positioned in the first opening of the first gear when the slot receives the second gear, wherein the guide plate is configured to maintain the second gear in engagement with the first gear as the second gear rotates and the guide plate rotates within the first opening.

2. The spiral decorating device of claim 1, wherein the guide plate comprises at least one post configured to allow a user to rotate the guide plate within the first opening while the second gear moves in engagement with the first gear and the second gear rotates.

3. The spiral decorating device of claim 1, further comprising a third gear configured to be positioned in the first opening and engage the first gear, wherein the third gear is configured to rotate around an axis of the third gear as the third gear moves in engagement with the first gear, and wherein the third gear defines a third opening configured for receiving another decorating item.

4. The spiral decorating device of claim 3, wherein the guide plate defines a second slot configured to receive the third gear, the guide plate configured to be positioned in the first opening of the first gear when the second slot receives the third gear, wherein the guide plate is configured to maintain the third gear in engagement with the first gear as the third gear rotates and the guide plate rotates within the first opening.

5. The spiral decorating device of claim 1, wherein the guide plate comprises a wall that defines the slot.

6. The spiral decorating device of claim 5, wherein upper and lower engagement surfaces extend from the wall of the guide plate, the upper and lower engagement surfaces engaging the second gear when the second gear is positioned in the slot.

7. A spin and spiral decorating device comprising:
a base comprising a first gear, the first gear defining a first opening around which the first gear extends;
a second gear configured to be positioned in the first opening and engage the first gear, wherein the second gear is configured to rotate around an axis of the second gear as the second gear moves in engagement with the first gear, and wherein the second gear defines a second opening configured for receiving a decorating item; and
a spin plate configured to rotatably engage the base with at least a portion of the spin plate extending through the first opening when the second gear is removed from the first opening.
